(19) United States
(12) Patent Application Publication
(10) Pub. No.: US 2014/0184119 A1
(43) Pub. Date: Jul. 3, 2014

(54) BRUSHLESS DIRECT CONTACT MOTOR DRIVING DEVICE AND METHOD OF CONTROLLING THE SAME

(71) Applicant: SAMSUNG ELECTRO-MECHANICS CO., LTD., Suwon (KR)

(72) Inventors: Jung Eun YOUM, Suwon (KR); Bon Young Gu, Suwon (KR)

(73) Assignee: Samsung Electro-Mechanics Co., Ltd., Suwon (KR)

(21) Appl. No.: 13/788,988

(22) Filed: Mar. 7, 2013

(30) Foreign Application Priority Data
Dec. 27, 2012 (KR) 10-2012-0155295

(51) Int. Cl. H02P 6/18

(52) U.S. Cl. CPC H02P 6/18
USPC 318/400.32

(57) ABSTRACT

There is provided a method of controlling a BLDC motor driving device, including aligning a rotor; storing alignment information of the rotor, determining whether the alignment of the rotor is correct or incorrect, and realigning the rotor based on the alignment information.

### CROSS-REFERENCE TO RELATED APPLICATIONS

This application claims the priority of Korean Patent Application No. 10-2012-0155295 filed on Dec. 27, 2012, in the Korean Intellectual Property Office, the disclosure of which is incorporated herein by reference.

### BACKGROUND OF THE INVENTION

1. Field of the Invention

The present invention relates to a brushless direct contact (BLDC) motor driving device, and more particularly, to a BLDC motor driving device having improved stability of motor driving and a method of controlling the same.

2. Description of the Related Art

A brushless DC motor is a DC motor driven with an electronic rectifier, without mechanical contact portions, such as a brush, a commutator, and the like, and includes a stator configured of a permanent magnet and a rotor including three phase coils or multiphase coils, rotating according to phase voltages of respective coils.

For the efficient driving of a brushless DC motor, commutation of each phase of the rotor needs to be performed in time, and for appropriate commutation, a position of the rotor needs to be detected. The position of the rotor may be detected using devices such as a hall sensor, a resolver, and the like. In this case, however, as a driving circuit may be complicated through the use thereof, a device for driving a brushless DC motor without a sensor has been developed.

Meanwhile, an operating mode of detecting a position of a rotor using an electrical circuit, instead of using a position detection device is called a sensorless operating mode.

For example, when a motor is driven without using a hall sensor, a method of obtaining positional information by detecting back electro-motive force (BEMF) has been widely used.

However, as back electro-motive force may not be detected during low-speed driving of a motor or stopping of a motor, it is difficult to accurately detect the positional information of the rotor when the motor is initially driven.

In this case, in order to drive a sensorless motor, a method of first aligning a rotor, accelerating the motor until the back electro-motive force of the motor is detected, detecting the back electro-motive force, and then controlling the speed of the motor has been used.

In this case, when a motor starts to rotate in a state in which the rotor is incorrectly aligned, a starting failure may occur. In addition, the starting failure will later inevitably be detected.

The Related Art Document below relates to a washing machine that may automatically re-start during an initial starting failure, but does not disclose a configuration in which a rotor is efficiently realigned during a starting failure thereof.

### RELATED ART DOCUMENT

Korean Patent Laid-Open Publication No. 10-2008-0027690

### SUMMARY OF THE INVENTION

An aspect of the present invention provides a BLDC motor driving device capable of rapidly detecting a starting failure at the time of initial driving of a motor and a method of controlling the same.

Another aspect of the present invention provides a BLDC motor driving device capable of detecting a starting failure of a motor and efficiently realigning a rotor in the case of a starting failure and a method of controlling the same.

According to an aspect of the present invention, there is provided a method of controlling a BLDC motor driving device, including: aligning a rotor; storing alignment information of the rotor; determining whether the alignment of the rotor is correct or incorrect; and realigning the rotor based on the alignment information.

The aligning of the rotor may include applying voltage to a first phase coil and a second phase coil in a three phase motor including the first phase coil, the second phase coil, and a third phase coil.

The storing of the alignment information may include storing information regarding the first phase coil and the second phase coil to which the voltage is applied in the three phase coils of the three phase motor.

The determining whether the alignment of the rotor is correct or incorrect may include: rotating the rotor; detecting information regarding whether the alignment of the rotor is correct or incorrect, based on a rotation of the rotor; and stopping the motor based on the information regarding whether the alignment of the rotor is correct or incorrect.

The detecting of the information regarding whether the alignment of the rotor is correct or incorrect may include: detecting at least one of angular velocity information of the motor, back electro-motive information of the motor, and current information of the inverter unit.

The determining whether the alignment of the rotor is correct or incorrect may be performed for a preset measuring time.

The determining whether the alignment of the rotor is correct or incorrect may be performed with a preset number of measurements.

The realigning may include applying voltage to the second phase coil and the third phase coil of the three phase coils of the three phase motor.

The realigning may include applying voltage to the first phase coil and the third phase coil of the three phase coils of the three phase motor.

According to another aspect of the present invention, there is provided an BLDC motor driving device, including: an inverter unit aligning a rotor; a storage unit storing alignment information of the rotor; and a control unit determining whether alignment of the rotor is correct or incorrect, wherein the inverter unit realigns the rotor based on the alignment information.

The inverter unit may apply voltage to a first phase coil and a second phase coil in a three phase motor including the first phase coil, the second phase coil, and a third phase coil.

The storage unit may store information regarding the first phase coil and the second phase coil to which the voltage is applied in the three phase coils of the three phase motor.

The inverter unit may rotate the rotor and the control unit may acquire information regarding whether the alignment of the rotor is correct or incorrect, based on a rotation of the rotor.

The information regarding whether the alignment of the rotor is correct or incorrect may include at least one of angular velocity information of the motor, back electro-motive information of the motor, and current information of the inverter unit.

The control unit may determine whether the alignment of the rotor is correct or incorrect for a preset measuring time.

The control unit may determine whether the alignment of the rotor is correct or incorrect with a preset number of measurements.

The inverter unit may apply voltage to the second phase coil and the third phase coil of the three phase coils of the three phase motor when the rotor is realigned.

The inverter unit may apply voltage to the first phase coil and the third phase coil of the three phase coils of the three phase motor when the rotor is realigned.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a sensorless BLDC motor driving device according to an embodiment of the present invention;

FIG. 2 is a diagram illustrating an example of an inverter unit included in the BLDC motor driving device;

FIG. 3 is a graph illustrating an initial driving operation of a motor according to the related art;

FIG. 4 is a flow chart illustrating a method of controlling a BLDC motor driving device according to the embodiment of the present invention; and

FIGS. 5A through 5C are diagrams illustrating an example of a method of aligning a rotor.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

An example of a motor described in the present specification may include a multiphase motor, such as a three phase motor, a four phase motor, and the like.

Hereinafter, for convenience of explanation, a driving device based on a three phase motor and a method of controlling the same will be described. However, it will be easily understood to those skilled in the art that the driving device based on a three phase motor and the method of controlling the same may also be applied to a multiphase motor.

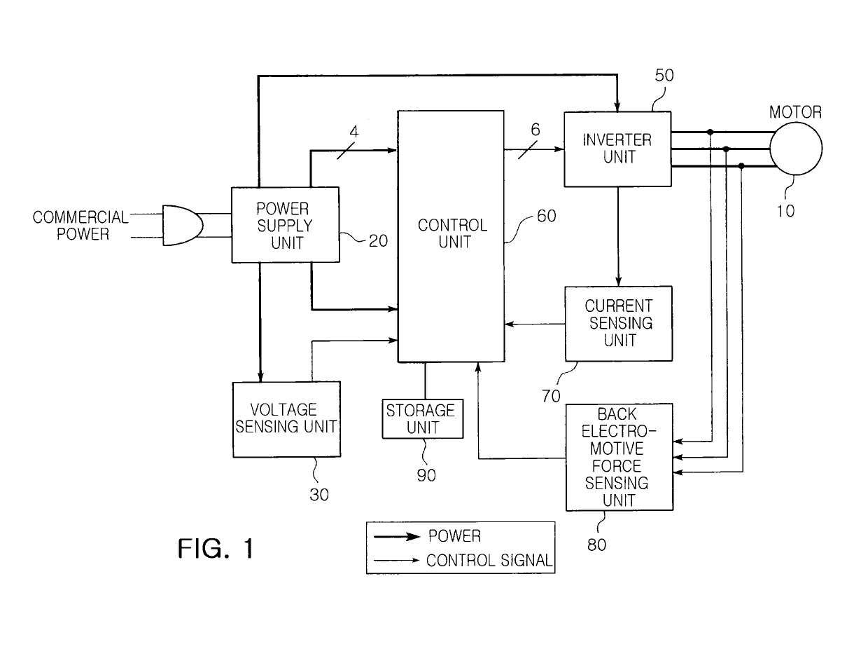

FIG. 1 is a block diagram of a sensorless BLDC motor driving device according to an embodiment of the present invention.

Referring to FIG. 1, the BLDC motor driving device may include a power supply unit 20, a voltage sensing unit 30, an inverter unit 50, a control unit 60, a current sensing unit 70, a back electro-motive force sensing unit 80, and a storage unit 90.

The power supply unit 20 may convert an AC voltage of commercial power into a DC voltage.

The inverter unit 50 converts the DC voltage from the power supply unit into a three phase (or multiphase) voltage, which may be in turn applied to respective coils of a BLDC motor 10. Current flowing in each phase by voltage applied to the coils of the BLDC motor generates a magnetic field in each coil of the motor 10, which may rotate a rotor mounted in the motor 10.

As described above, when the motor 10 rotates, back electro-motive force may be generated in the coils mounted in the rotor 10.

Further, the inverter unit 50 may align the rotor. For example, the inverter unit 50 may apply voltage to a first phase coil and a second phase coil in the three phase motor including the first phase coil, the second phase coil, and the third phase coil.

As described above, the back electro-motive force sensing unit 80 may detect the back electro-motive force generated from each coil of the brushless DC motor 10 and apply the detected back electro-motive force to the control unit 60.

The control unit 60 may analyze a back electro-motive force detection signal to control the inverter unit 50 so as to drive the motor 10 to be suitable therefor. For example, the control unit 60 switching-drives the inverter unit 50 to control the phase voltage applied to the motor 10.

Further, the control unit may determine whether the alignment of the rotor is correct or incorrect.

Meanwhile, the current sensing unit 70 may sense current applied to the motor 10. Further, the voltage sensing unit 30 may sense voltage applied to the motor 10.

Meanwhile, the control unit 60 may control the driving of the inverter unit 50, based on current information from the current sensing unit 70 and voltage information from the voltage sensing unit 30. For example, the control unit 60 may block power applied to the motor 10 when an overvoltage or an overcurrent is applied to the motor 10, so as to stably drive the motor.

The storage unit 90 may store alignment information of the rotor. For example, the storage unit 90 may store information regarding to which the voltage is applied in the three phase coils of the three phase motor.

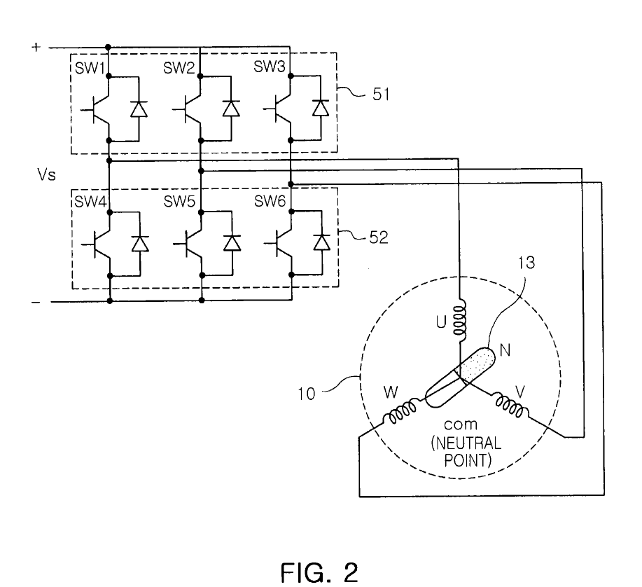

FIG. 2 is a diagram illustrating an example of an inverter unit included in the BLDC motor driving device.

Referring to FIG. 2, the inverter unit 51 may include a plurality of upper switch elements SW1 through SW3 51 connected to a positive power supply terminal and a plurality of lower switch elements SW4 through SW6 52 provided between the respective upper switch elements SW1 through SW3, and a negative power supply terminal.

Meanwhile, contacts between the respective upper switch elements SW1 through SW3 and the respective lower switch elements SW4 through SW6 maybe connected with respective coils U, V, and W of the brushless DC motor 10.

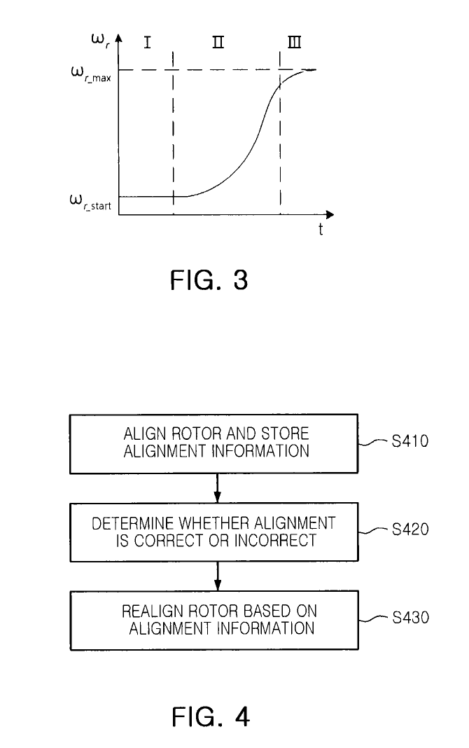

FIG. 3 is a graph illustrating a motor initial driving operation of the related art.

Referring to FIG. 3, the initial driving operation of the motor may be configured of an alignment period I, an acceleration period II, and a control period III.

The alignment period I is a period in which the rotor is aligned at a predetermined position.

The acceleration period II is a period in which the rotor starts to rotate when voltage is applied to the coil of the motor.

The control period III is a period in which the back electro-motive force is detected to control the motor at a required speed.

According to the existing method, in order to drive the motor, the rotor is first aligned, the motor is accelerated until the back electro-motive force of the motor is detected, the back electro-motive force is detected, and the speed of the motor is then controlled. In addition, the starting failure of the motor may be detected in the control period III.

According to the embodiment of the present invention, it may be determined whether the alignment of the rotor is correct in the acceleration period II, such that the starting failure of the motor may be detected rapidly. Further, the stability of the driving of the motor may be improved.

FIG. 4 is a flow chart illustrating a method of controlling a BLDC motor driving device according to the embodiment of the present invention.

The method of controlling a BLDC motor driving device according to the embodiment of the present invention may include aligning the rotor (S410).

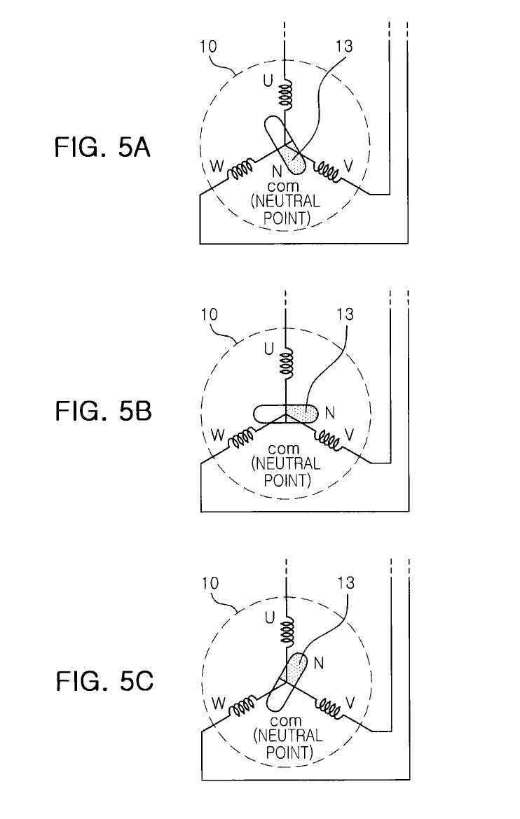

FIGS. 5A through 5C are diagrams illustrating an example of a method of aligning a rotor.

Referring to FIG. 5A, the rotor 13 may be aligned in a direction orthogonal with respect to the W phase coil of the BLDC motor 10.

Referring to FIGS. 2 and 5, for example, the switch element SW1 is turned on and the switch element SW6 is turned on, such that positive (+) voltage may be applied to the U phase coil of the BLDC motor 10 and negative (−) voltage may be applied to the W phase coil thereof. Therefore, magnetic forces having opposite polarities are generated between the U phase coil and the W phase coil and the rotor 13 may be aligned due to the interaction of the magnetic forces.

Alternatively, the switch element SW3 is turned on and the switch element SW4 is turned on, such that negative voltage may be applied to the U phase coil of the BLDC motor 10 and positive voltage may be applied to the W phase coil thereof.

Therefore, magnetic forces having opposite polarities are generated between the U phase coil and the W phase coil, and the rotor 13 may be aligned due to the interaction of the magnetic forces.

Referring to FIG. 5B, the rotor 13 may be aligned in a direction orthogonal with respect to the U phase coil of the BLDC motor 10.

Referring to FIGS. 2 and 5, for example, the switch element SW3 is turned on and the switch element SW5 is turned on, such that positive voltage may be applied to the W phase coil of the BLDC motor 10 and negative voltage may be applied to the V phase coil thereof. Therefore, magnetic forces having opposite polarities are generated between the W phase coil and the V phase coil, and the rotor 13 may be aligned due to the interaction of the magnetic forces.

Alternatively, the switch element SW2 is turned on and the switch element SW6 is turned on, such that negative voltage may be applied to the W phase coil of the BLDC motor 10 and positive voltage may be applied to the V phase coil thereof. Therefore, magnetic forces having opposite polarities are generated between the W phase coil and the V phase coil, and the rotor 13 may be aligned due to the interaction of the magnetic forces.

Referring to FIG. 5C, the rotor 13 may be aligned in a direction orthogonal with respect to a W phase coil of the BLDC motor 10.

Referring to FIGS. 2 and 5, for example, the switch element SW2 is turned on and the switch element SW4 is turned on, such that positive voltage may be applied to the V phase coil of the BLDC motor 10 and negative voltage may be applied to the U phase coil thereof. Therefore, magnetic forces having opposite polarities are generated between the V phase coil and the U phase coil, and the rotor 13 may be aligned due to the interaction of the magnetic forces.

Alternatively, the switch element SW1 is turned on and the switch element SW5 is turned on, such that negative voltage may be applied to the V phase coil of the BLDC motor 10 and positive voltage may be applied to the U phase coil thereof. Therefore, magnetic forces having opposite polarities are generated between the V phase coil and the U phase coil and the rotor 13 may be aligned due to the interaction of the magnetic forces.

Referring to FIG. 4, the method of controlling a BLDC motor driving device according to the embodiment of the present invention may include storing the alignment information (S410).

For example, the storage unit 90 may store the alignment information.

As illustrated in FIGS. 5A through 5C, when voltage is applied to two phases of the three phase coils of the three phase motor including the U phase coil, the V phase coil, and the W phase coil, the position of the rotor may be determined.

In this case, the alignment information may include the alignment type of the rotor.

Further, the alignment information may include information regarding coils to which voltage is applied in the three phase coils of the three phase motor. For example, as illustrated in FIG. 5A, when the rotor is aligned, the alignment information may include information indicating that voltage is applied to the U phase coil and the W phase coil of the motor. Further, as illustrated in FIG. 5B, when the rotor is aligned, the alignment information may include information indicating that voltage is applied to the W phase coil and the V phase coil of the motor. Further, as illustrated in FIG. 5C, when the rotor is aligned, the alignment information may include information indicating that voltage is applied to the V phase coil and the U phase coil of the motor.

The method of controlling a BLDC motor driving device according to the embodiment of the present invention may include determining whether the alignment of the rotor is correct or incorrect (S420).

For example, the inverter unit 50 of the BLDC motor driving device may rotate the rotor.

The control unit 60 may obtain the information regarding whether the alignment of the rotor is correct or incorrect, based on the rotation of the rotor.

The information regarding whether the alignment of the rotor is correct or incorrect may include the information required to determine whether the rotor is accurately disposed. For example, the information regarding whether the alignment of the rotor is correct or incorrect may include angular velocity information of the rotor, the back electro-motive force information of the motor, and the current information of the inverter unit.

First, a method of determining whether the alignment of the rotor is correct or incorrect based on the current information of the inverter unit will be described.

According to the embodiment of the present invention, the current sensing unit 70 may measure the current of the inverter unit. Further, the control unit 60 may obtain the current information measured by the inverter unit from the current sensing unit 70.

Meanwhile, the storage unit 90 may store normal current information in the acceleration period of the motor. The normal current information may include the current information measured in the acceleration period when the rotor is accurately disposed.

Therefore, the control unit 60 may determine whether the alignment of the rotor is in a normal state, based on the current information and the normal current information of the inverter unit.

Further, the method of determining whether the alignment of the rotor is correct or incorrect based on the back electro-motive force information of the motor will be described.

According to the embodiment of the present invention, the back electro-motive force sensing unit 80 may measure the back electro-motive force of the motor. Further, the control unit 60 may obtain the back electro-motive force information of the motor from the back electro-motive force sensing unit 80.

Meanwhile, the storage unit 90 may store the normal back electro-motive force information in the acceleration period of the motor. The normal back electro-motive force information may include the back electro-motive force information measured in the acceleration period when the rotor is accurately disposed.

Therefore, the control unit 60 may determine whether the alignment of the rotor is in a normal state, based on the back electro-motive force information and the normal back electro-motive force information of the motor.

Further, the method of determining whether the alignment of the rotor is correct or incorrect based on the angular velocity information of the rotor will be described.

According to the embodiment of the present invention, an angular velocity sensing unit may measure the angular velocity of the rotor. Further, the control unit 60 may obtain the angular velocity information of the rotor from the angular velocity sensing unit.

Meanwhile, the storage unit 90 may store the normal angular velocity information in the acceleration period of the motor. The normal angular velocity information may include the angular velocity information measured in the acceleration period when the rotor is accurately disposed.

Therefore, the control unit 60 may determine whether the alignment of the rotor is in a normal state, based on the angular velocity information and the normal angular velocity information of the motor.

Meanwhile, the control unit 60 may determine whether the alignment of the rotor is correct or incorrect for a preset measuring time.

For example, the control unit 60 may compare the current information and the normal current information of the inverter unit for the preset measuring time to determine whether the alignment of the rotor is in a normal state. In detail, the control unit 60 may determine whether the alignment of the rotor is in an abnormal state, when the current information of the inverter unit does not reach a predetermined value within the preset measuring time.

Further, the control unit 60 may compare the back electro-motive force information and the normal back electro-motive force information of the motor for the preset measuring time to determine whether the alignment of the rotor is in a normal state. In detail, the control unit 60 may determine that the alignment of the rotor is in an abnormal state, when the back electro-motive force information of the motor does not reach a predetermined value within the preset measuring time.

Further, the control unit 60 may compare the angular velocity information and the normal angular velocity information of the motor for the preset measuring time to determine whether the alignment of the rotor is in a normal state. In detail, the control unit 60 may determine that the alignment of the rotor is in an abnormal state, when the angular velocity information of the motor does not reach a predetermined value within the preset measuring time.

Meanwhile, the control unit 60 may determine whether the alignment of the rotor is correct or incorrect with a preset number of measurements.

For example, the control unit 60 may compare the current information and the normal current information of the inverter unit with a preset number of measurements to determine whether the alignment of the rotor is in a normal state. In detail, the control unit 60 may determine that the alignment of the rotor is in an abnormal state, when the current information of the inverter unit does not reach a predetermined value within the preset number of measurements.

Further, the control unit 60 may compare the back electro-motive force information and the normal back electro-motive force information of the motor for the preset measuring time to determine whether the alignment of the rotor is in a normal state. In detail, the control unit 60 may determine that the alignment of the rotor is in an abnormal state, when the back electro-motive force information of the motor does not reach a predetermined value within the preset number of measurements.

Further, the control unit 60 may compare the angular velocity information and the normal angular velocity information of the motor with the preset number of measurements to determine whether the alignment of the rotor is in a normal state. In detail, the control unit 60 may determine that the alignment of the rotor is in an abnormal state, when the angular velocity information of the motor does not reach a predetermined value within the preset number of measurements.

According to the embodiment of the present invention, the BLDC motor driving device and the method of controlling the same, in which the starting failure may be rapidly detected at the time of the initial driving of the motor.

Meanwhile, according to the embodiment of the present invention, the control unit 60 may stop the motor based on the information regarding whether the alignment of the rotor is correct or incorrect. For example, the control unit 60 may stop the motor and realign the rotor when it is determined that the alignment of the rotor is in an abnormal state.

The method of controlling a BLDC motor driving device according to the embodiment of the present invention may include realigning the rotor based on the alignment information (S430).

That is, the inverter unit 50 may realign the rotor, based on the alignment information.

Meanwhile, for convenience of explanation, in connection with the three phase motor including the U phase coil, the V phase coil, and the W phase coil, the two phases to which voltage is applied in the aligning of the rotor are defined as a first phase and a second phase. Further, in the aligning of the rotor, the remaining one phase to which voltage is not applied is defined as a third phase.

According to the embodiment of the present invention, the BLDC motor driving device may realign the motor by applying voltage to the second phase coil and the third phase coil of the three phase coils of the three phase motor.

Further, the BLDC motor driving device may realign the motor by applying voltage to the first phase coil and the third phase coil of the three phase coils of the three phase motor.

That is, in the realigning of the rotor according to the embodiment of the present invention based on the alignment information (S410), the BLDC motor driving device may apply the voltage to the coil of the phase to which voltage is not applied.

Since the alignment information includes the information regarding the coil to which voltage is applied in the aligning of the rotor (S410) in the three phase coils of the three phase motor, the BLDC motor driving device may newly align the rotor.

That is, since the rotor is aligned in the realigning of the rotor (S430) by a method different from the aligning of the rotor (S410), it may be determined whether the alignment of the rotor without errors before is correct or incorrect in the realigning of the rotor (S430).

Therefore, in the BLDC motor driving device and the method of controlling the same according to the embodiment of the present invention, the starting failure of the motor may be detected and the rotor may be efficiently re-aligned.

As set forth above, according to the embodiments of the present invention, the BLDC motor driving device and the method of controlling the same may rapidly detect the starting failure at the time of the initial driving of the motor.

Further, according to the present invention, the BLDC motor driving device and the method of controlling the same may detect the starting failure of the motor and efficiently realign the rotor.

While the present invention has been shown and described in connection with the embodiments, it will be apparent to those skilled in the art that modifications and variations may be made without departing from the spirit and scope of the invention as defined by the appended claims.

What is claimed is:

1. A method of controlling a brushless direct contact (BLDC) motor driving device, comprising:
aligning a rotor;
storing alignment information of the rotor;
determining whether the alignment of the rotor is correct or incorrect; and
realigning the rotor based on the alignment information.

2. The method of claim 1, wherein the aligning of the rotor includes applying voltage to a first phase coil and a second phase coil in a three phase motor including the first phase coil, the second phase coil, and a third phase coil.

3. The method of claim 2, wherein the storing of the alignment information includes storing information regarding the first phase coil and the second phase coil to which the voltage is applied in the three phase coils of the three phase motor.

4. The method of claim 1, wherein the determining whether the alignment of the rotor is correct or incorrect includes:
rotating the rotor;
detecting information regarding whether the alignment of the rotor is correct or incorrect, based on a rotation of the rotor; and
stopping the motor based on the information regarding whether the alignment of the rotor is correct or incorrect.

5. The method of claim 4, wherein the detecting of the information regarding whether the alignment of the rotor is correct or incorrect includes:
detecting at least one of angular velocity information of the motor, back electro-motive information of the motor, and current information of the inverter unit.

6. The method of claim 1, wherein the determining whether the alignment of the rotor is correct or incorrect is performed for a preset measuring time.

7. The method of claim 1, wherein the determining whether the alignment of the rotor is correct or incorrect is performed with a preset number of measurements.

8. The method of claim 2, wherein the realigning includes applying voltage to the second phase coil and the third phase coil of the three phase coils of the three phase motor.

9. The method of claim 2, wherein the realigning includes applying voltage to the first phase coil and the third phase coil of the three phase coils of the three phase motor.

10. A BLDC motor driving device, comprising:
an inverter unit aligning a rotor;
a storage unit storing alignment information of the rotor; and
a control unit determining whether alignment of the rotor is correct or incorrect,
wherein the inverter unit realigns the rotor based on the alignment information.

11. The BLDC motor driving device of claim 10, wherein the inverter unit applies voltage to a first phase coil and a second phase coil in a three phase motor including the first phase coil, the second phase coil, and a third phase coil.

12. The BLDC motor driving device of claim 11, wherein the storage unit stores information regarding the first phase coil and the second phase coil to which the voltage is applied in the three phase coils of the three phase motor.

13. The BLDC motor driving device of claim 10, wherein the inverter unit rotates the rotor and the control unit acquires information regarding whether the alignment of the rotor is correct or incorrect, based on a rotation of the rotor.

14. The BLDC motor driving device of claim 13, wherein the information regarding whether the alignment of the rotor is correct or incorrect includes at least one of angular velocity information of the motor, back electro-motive information of the motor, and current information of the inverter unit.

15. The BLDC motor driving device of claim 10, wherein the control unit determines whether the alignment of the rotor is correct or incorrect for a preset measuring time.

16. The BLDC motor driving device of claim 10, wherein the control unit determines whether the alignment of the rotor is correct or incorrect with a preset number of measurements.

17. The BLDC motor driving device of claim 11, wherein the inverter unit applies voltage to the second phase coil and the third phase coil of the three phase coils of the three phase motor when the rotor is realigned.

18. The BLDC motor driving device of claim 11, wherein the inverter unit applies voltage to the first phase coil and the third phase coil of the three phase coils of the three phase motor when the rotor is realigned.
